(19) United States
(12) Patent Application Publication
(10) Pub. No.: US 2026/0233098 A1
(43) Pub. Date: Aug. 13, 2026

(54) RECORDING MEDIUM RECORDING INFORMATION PROCESSING PROGRAM, INFORMATION PROCESSING METHOD, AND INFORMATION PROCESSING APPARATUS

(71) Applicant: KOEI TECMO GAMES CO., LTD., Yokohama-shi (JP)

(72) Inventor: Yuto MISHIMA, Kanagawa (JP)

(21) Appl. No.: 19/444,206

(22) Filed: Jan. 9, 2026

(30) Foreign Application Priority Data
Feb. 12, 2025 (JP) 2025-021079

(51) Int. Cl. A63F 13/5378; A63F 13/69

(52) U.S. Cl. CPC A63F 13/5378; A63F 13/69

(57) ABSTRACT

A non-transitory recording medium storing an information processing program that is executable by a computer to perform processing including, in a game in which a marker indicating an occurrence location of each event in an area in which a plurality of events are set to occur is displayed on a map screen showing the area, changing display content of a marker that is displayed in the area on the map screen in accordance with a change in an index indicating a relationship of a player character with respect to the area.

### CROSS-REFERENCE TO RELATED APPLICATION

This application is based on and claims priority under 35 USC 119 from Japanese Patent Application No. 2025-021079, filed on February 12, 2025, the entire disclosure of which is incorporated by reference herein.

### BACKGROUND

### Technical Field

The present disclosure relates to a recording medium recording an information processing program, an information processing method, and an information processing apparatus.

### Related Art

Japanese Patent Application Laid-Open (JP-A) No. 2014-023864 discloses a game providing a reward to a player on condition that it is determined that an event occurs.

### SUMMARY OF THE INVENTION

In recent open world games, in order to generate an event in which the reward is provided, a mechanism for mapping an occurrence location of the event on a map is generally adopted. In the conventional mechanism, an occurrence location of a new event is often mapped by a player character acquiring a specific item such as a treasure map, and it is necessary to individually design an occurrence location of each event.

Therefore, conventionally, in a case in which there are a plurality of events, it is necessary to individually design coordinates, related data, and the like for each event, and there has been a problem in that the efficiency of game development decreases and the development cost increases.

Therefore, an object of the disclosure is to provide a recording medium recording an information processing program, an information processing method, and an information processing apparatus by which the time and effort required to design an event occurrence location can be reduced as compared with the case of individually designing an occurrence location of each event in a game in which a plurality of events exist.

A first aspect is a non-transitory recording medium storing an information processing program that is executable by a computer to perform processing comprising: in a game in which a marker indicating an occurrence location of each event in an area in which a plurality of events are set to occur is displayed on a map screen showing the area, changing display content of a marker that is displayed in the area on the map screen in accordance with a change in an index indicating a relationship of a player character with respect to the area. According to the information processing program, the time and effort required to design an event occurrence location can be reduced as compared with the case of individually designing an occurrence location of each event in a game in which a plurality of events are set to occur.

A second aspect is a non-transitory recording medium storing an information processing program. In the information processing program according to the first aspect, the information processing program is executable by a computer, wherein the processing further comprises: further changing display content of a marker that is displayed in the area to add a marker in the area with an increase in a level of the area, wherein the index is the level, which is set for the area and increases when a relationship of the player character with respect to the area is deepened. According to the information processing program, with an increase in the level set for the area, a marker that is displayed in the area is added, and therefore, in a game in which a plurality of events are set to occur, an occurrence location of each event can be managed in a stepwise manner, and the time and effort required to design an occurrence location of each event can be further reduced as compared with the case of individually designing an occurrence location of each event.

A third aspect is a non-transitory recording medium storing an information processing program. In the information processing program according to the second aspect, the level is increased by the player character generating an event in the area. According to the information processing program, since there is a case in which the level is increased by the player character generating an event in the area and the marker can be added, the action of the player character is reflected as a visual change of the map screen, and the sense of achievement of the search can be given.

A fourth aspect is a non-transitory recording medium storing an information processing program. In the information processing program according to the second or third aspect, the information processing program is executable by a computer, wherein the processing further comprises: further changing display content of a marker that is displayed in the area to add a marker indicating a location of at least one of an event that has not yet occurred or an event that has occurred but has not been cleared by the player, when a level of the area has been increased. According to the information processing program, by adding, at the time of the level increase, an additional marker indicating a location of at least one of an event that has not yet occurred or an event that has occurred but has not been cleared by the player, the next action of the player character can be visually guided.

A fifth aspect is a non-transitory recording medium storing an information processing program. In the information processing program according to any one of the second to fourth aspects, the information processing program is executable by a computer, wherein the processing further comprises: repeatedly providing a reward to the player character in a case in which an event at which the reward is available as a benefit obtained at the maximum level repeatedly occurs in the area. According to the information processing program, since the reward can be repeatedly provided to the player character at an event at which the reward is available as a benefit obtained at the maximum level, it is possible to give a player a continuous sense of achievement and improve motivation for continuing the play in the area.

An information processing method according to a sixth aspect causes a computer to execute processing comprising: in a game in which a marker indicating an occurrence location of each event in an area in which a plurality of events are set to occur is displayed on a map screen showing the area, changing display content of a marker that is displayed in the area on the map screen in accordance with a change in an index indicating a relationship of a player character with respect to the area. According to the information processing method, the time and effort required to design an event occurrence location can be reduced as compared with the case of individually designing an occurrence location of each event in a game in which a plurality of events are set to occur.

An information processing apparatus according to a seventh aspect comprises a processor, wherein, in a game in which a marker indicating an occurrence location of each event in an area in which a plurality of events are set to occur is displayed on a map screen showing the area, the processor changes display content of a marker that is displayed in the area on the map screen in accordance with a change in an index indicating a relationship of a player character with respect to the area. According to the information processing apparatus, the time and effort required to design an event occurrence location can be reduced as compared with the case of individually designing an occurrence location of each event in a game in which a plurality of events are set to occur.

According to the recording medium recording an information processing program, the information processing method, and the information processing apparatus according to the disclosure, the time and effort required to design an event occurrence location can be reduced as compared with the case of individually designing an occurrence location of each event in a game in which a plurality of events are set to occur.

### BRIEF DESCRIPTION OF THE DRAWINGS

Exemplary embodiments of the present disclosure will be described in detail based on the following figures, wherein:

FIG. 1 is a diagram illustrating a schematic configuration of an information processing apparatus;

FIG. 2 is a block diagram illustrating a functional configuration of the information processing apparatus;

FIG. 3 is a flowchart illustrating a flow in which specific processing is executed;

FIG. 4 is a first display example of a map screen displayed on a display;

FIG. 5 is a second display example of the map screen displayed on the display; and

FIG. 6 is a third display example of the map screen displayed on the display.

### DETAILED DESCRIPTION OF THE INVENTION

Hereinafter, an information processing apparatus 10 according to the present embodiment will be described.

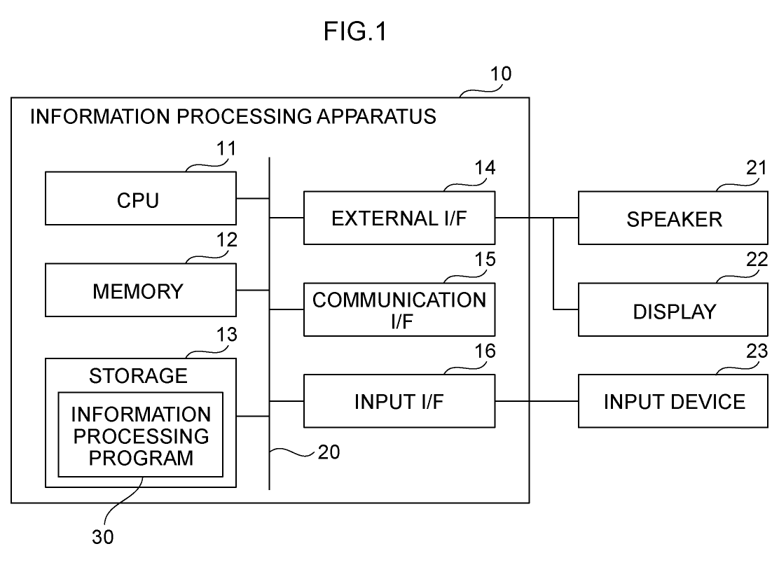

First, a hardware configuration of the information processing apparatus 10 according to the embodiment will be described with reference to FIG. 1. The information processing apparatus 10 is, for example, a home game machine, a portable game machine, a business game machine, a smartphone, a tablet terminal, a personal computer, or the like. In the embodiment, an example in which a home game machine is applied as the information processing apparatus 10 will be described. The information processing apparatus 10 is an example of the “information processing apparatus” of the disclosure and the “computer”.

As illustrated in FIG. 1, the information processing apparatus 10 includes a central processing unit (CPU) 11, a memory 12, a storage 13, an external interface (I/F) 14, a communication I/F 15, and an input I/F 16. The CPU 11, the memory 12, the storage 13, the external I/F 14, the communication I/F 15, and the input I/F 16 are communicably connected to each other via a bus 20.

The CPU 11 is a central processing unit, and executes various programs or controls each unit. The CPU 11 is an example of the “processor” of the disclosure. The memory 12 temporarily stores a program or data as a workspace. The storage 13 includes a storage device such as a hard disk drive (HDD), a solid state drive (SSD), or a flash memory, and stores various programs and various data.

The information processing program 30 for executing a predetermined game in the information processing apparatus 10 is stored in the storage 13. The information processing program 30 is an example of the “information processing program” of the disclosure. The CPU 11 reads out the information processing program 30 from the storage 13, and executes the information processing program 30 using the memory 12 as a workspace. The information processing program 30 is not limited to a mode of being stored in the storage 13, and may be stored in a recording medium such as an optical disk, a universal serial bus (USB) memory, or an SD memory card. The information processing program 30 may be downloadable to the information processing apparatus 10 via the communication I/F 15.

The external I/F 14 is an interface for connecting various external devices to the information processing apparatus 10. In the embodiment, a speaker 21 and a display 22 are connected to the external I/F 14.

The speaker 21 outputs various sounds. The speaker 21 may be integrated with the information processing apparatus 10 or may be integrated with the display 22. The display 22 is, for example, a liquid crystal display or an organic electro luminescence (EL) display, and displays various types of information. The display 22 may integrally include a touch panel. The display 22 may be integrated with the information processing apparatus 10.

The communication I/F 15 is an interface for connecting the information processing apparatus 10 to a network. For the communication I/F 15, for example, a wired communication standard such as Ethernet (registered trademark) or fiber distributed data interface (FDDI), or a wireless communication standard such as 4G, 5G, or Wi-Fi (registered trademark) is used.

The input I/F 16 is an interface for connecting an input device 23 to the information processing apparatus 10. The input device 23 is a controller having operation buttons, direction keys, and the like, a mouse, a keyboard, and the like, and is used to perform various inputs. A player operates a game using the input device 23. Operation information indicating the content of the input operation performed by the player using the input device 23 is stored in the memory 12. The input device 23 may be integrated with the information processing apparatus 10. The input device 23 may be detachable from the information processing apparatus 10. The number of input devices 23 may be one or more. The input device 23 may be a touch panel integrated with the display 22. In the embodiment, an example in which a controller is applied as the input device 23 will be described.

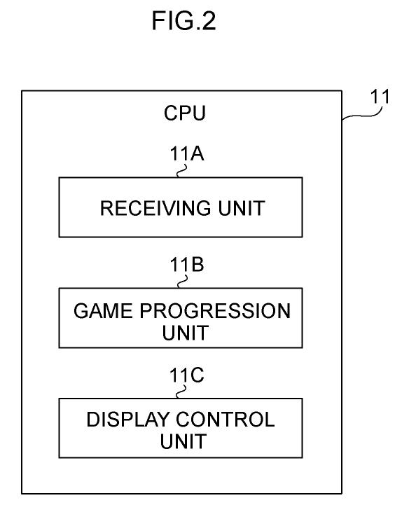

Next, a functional configuration of the information processing apparatus 10 will be described. FIG. 2 is a block diagram illustrating an example of a functional configuration of the information processing apparatus 10.

As illustrated in FIG. 2, the CPU 11 of the information processing apparatus 10 includes, as functional configurations, a receiving unit 11A, a game progression unit 11B, and a display control unit 11C. Each functional configuration is realized by the CPU 11 reading out and executing the information processing program 30 stored in the storage 13.

The receiving unit 11A receives an input operation from the player using the input device 23.

The game progression unit 11B controls the progress of the game on the basis of the input operation of the player received by the receiving unit 11A, the information defined in the information processing program 30, and the like. The game described herein is a set of activities and rules for performing play and competition. The game is played, for example, by the player using strategies and skills to achieve specific goals. The game is played to achieve various goals, for example, a goal in competition such as a win, a goal in a battle such as beating an enemy, an educational goal such as learning, a narrative goal such as completing the progress of a scenario, and the like. The game may be a format of competing against each other or a format of not competing against each other.

Hereinafter, a game played by the information processing apparatus 10 will be described as a game in which a marker indicating an occurrence location of each event in an area in which a plurality of events are set to occur is displayed on a map screen showing the area (hereinafter, referred to as “this game”).

The event indicates a specific goal, an action guideline, and the like provided to a player character in this game. A specific example of the event will be described later.

The player character refers to a character operated by the player in this game, and includes a human, an animal, a robot, a machine, an imaginary creature, or the like, but a type thereof is not particularly limited.

The area refers to a specific section set in the game, and is a unit in which the player character can move and an event is executed. Areas are divided on the basis of geographical characteristics, themes in this game, and the like, and terrain and events corresponding to the respective areas are set. A plurality of events are associated with each area. The fact that a plurality of events are associated with an area means that the content, occurrence condition, and the like of the events occurring in a specific area are defined on the basis of the geographical characteristics of the area, the set theme, and the like.

The map screen is a screen indicating the topography according to the area.

The marker indicates an occurrence location of each event in the area. The player can generate a corresponding event by moving the player character to a location indicated by the marker.

The display control unit 11C controls the display content of the display 22 on the basis of the input operation of the player received by the receiving unit 11A, the information defined in the information processing program 30, and the like.

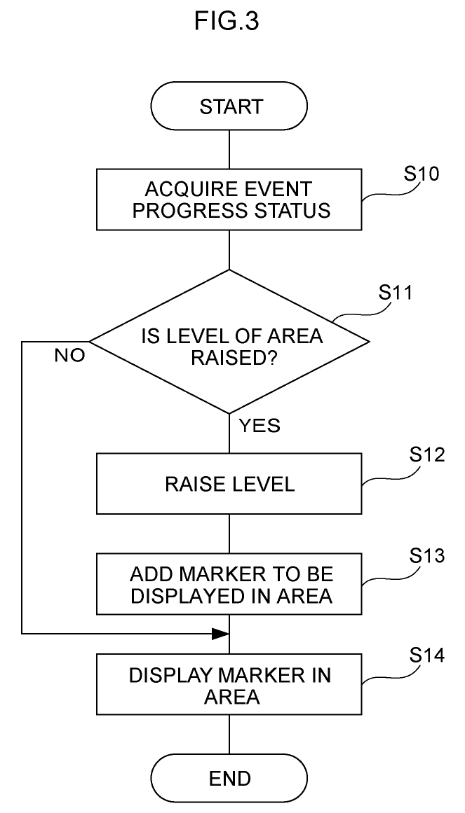

FIG. 3 is a flowchart illustrating a flow of specific processing executed by the information processing apparatus 10. The CPU 11 reads out the information processing program 30 from the storage 13, develops the information processing program in the memory 12, and executes the information processing program, whereby the specific processing is performed. The specific processing illustrated in FIG. 3 is executed, for example, in a case in which an operation of opening the map screen is received.

In step S10 illustrated in FIG. 3, the CPU 11 acquires the progress status of the event in the area on the map screen from the storage 13. A progress status of an event set for each of a plurality of areas in this game is stored in the storage 13. Then, the CPU 11 proceeds to step S11.

The “progress status of the event” described herein indicates the progress of the entire event in each area, and is evaluated on the basis of the occurrence rates of all events, the presence or absence of occurrence of an individual event, and the like. The occurrence rate of all events is indicated by a ratio in which the number of events having occurred among all events set in the area is represented as a numerator and the total number of all events is represented as a denominator (e.g.: 5/20 or 15/30). The presence or absence of occurrence of an individual event indicates whether or not a specific event has occurred. The progress status of the event changes when the CPU 11 causes an event to occur in the area in response to the player character satisfying a condition, or when the player clears an event that has occurred. For example, in a case in which the CPU 11 causes a new event to occur when a specific condition is satisfied or when the player clears an event that has occurred, the progress status thereof is updated.

The progress status of the event affects an index indicating a relationship of the player character with respect to the area. In this game, the index is regarded as a “level” that is set for the area, and the level increases when the relationship of the player character with respect to the area is deepened. That is, in this game, the progress status of the event affects a change in level. Specifically, in this game, when the progress status of the event satisfies a predetermined criterion, the relationship between the player character and the area is deepened, and the level increases.

In step S11, the CPU 11 determines whether or not to raise the level of the area on the basis of the progress status of the event acquired in step S10. In a case in which it is determined to raise the level (step S11: YES), the CPU 11 proceeds to step S12. On the other hand, in a case in which it is determined to maintain the level (step S11: NO), the CPU 11 proceeds to step S14.

The level described herein may increase when the CPU 11 causes an event to occur in the area or when the player clears an event that has occurred, so that the progress status of the event satisfies a predetermined criterion. In this game, the level in the initial state is “0”, but the level increases to “1” when the CPU 11 causes one event to occur, and thereafter, the marker that is displayed in the area on the map screen changes in accordance with the increased level. A specific example in which the marker in the area changes will be described later.

In this game, for example, the progress status of the event is updated by generating or clearing the following event, and the level increases from “1” to “2” and from “2” to “3” in a case in which the progress status after the update satisfies a predetermined criterion. The levels are set to four levels from “0” to “3”, but are not limited thereto, and can also be set to three levels or less or five levels or more.

(1) Search Event

A search event is an event of searching and finding each element set in an area. The function of efficiently moving the player character may be unlocked by finding a specific location in the search event.

(2) Collection Event

A collection event is an event of collecting a collectible item scattered in an area. The type of collectible items is not limited, and includes a living organism (e.g.: a human or an animal), an article (e.g.: an item or a treasure chest), and the like.

(3) Environment Improvement Event

An environment improvement event is an event for improving safety by eliminating an enemy character in an area. In a case in which the environment improvement event occurs, in addition to the rising of the level, a new event or collectible item may be unlocked. On the other hand, in a case in which an enemy character is not eliminated, the environment of the area deteriorates, and the action of the player character may be temporarily limited.

(4) Request Event

A request event is an event for achieving a request presented by a resident in an area.

(5) Random Event

A random event is a short-term event that occurs irregularly in an area.

(6) Action Event

An action event is an event in which the player character executes a specific action (e.g.: photographing or predetermined training) in the area. In a case in which the action event occurs, the ability of the player character can be improved in addition to the rising of the level.

(7) Famous Site Event

A famous site event is an event of discovering a famous site (e.g.: a historical place or a symbolic topography) set in an area. In a case in which the famous site event occurs, a reward such as an experience value may be acquired in addition to the rising of the level.

(8) Symbolic Action Event

A symbolic action event is an event in which the player character executes a specific symbolic action (e.g.: worship) in an area. In a case in which the symbolic action event occurs, the ability of the player character can be improved in addition to the rising of the level.

Even in a case in which all the events are cleared, the level does not reach the maximum value “3” in some cases. In this case, it is necessary to clear an uncleared event in the area or to clear a newly occurring event. This makes it possible to finally raise the level to “3”.

In step S12, the CPU 11 raises the level set in the area on the basis of the progress status of the event acquired in step S10. For example, the CPU 11 raises the level from “1” to “2” or from “2” to “3”. Then, the CPU 11 proceeds to step S13.

In step S13, the CPU 11 adds a marker that is displayed in an area on the map screen in accordance with the level after the level has been increased. In this game, a marker that is displayed in an area changes on the basis of a change in level as an index, and the number, types, and the like of markers that are displayed increase when the level increases. For example, when the level increases, the marker that is displayed changes, so that locations of undiscovered collectible items and unoccurred action events are indicated through a new marker. In this manner, the addition of the marker when the level increases plays a role in guiding the action of the player character through the map screen. When the level reaches the maximum value “3”, all the markers set in the area are displayed. Then, the CPU 11 proceeds to step S14.

In step S14, the CPU 11 causes a marker corresponding to the current level to be displayed in the area on the map screen. The CPU 11 ends the specific processing.

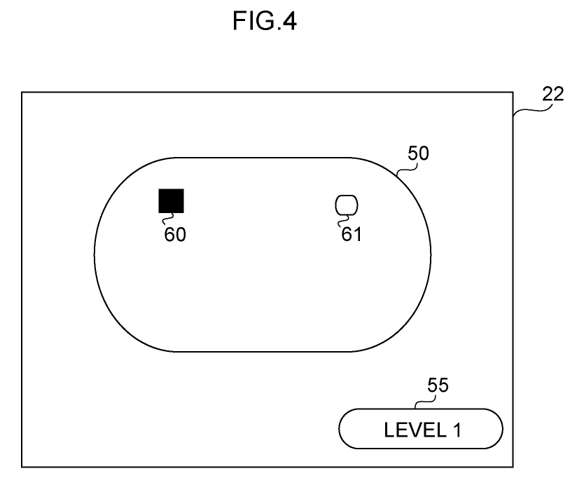

FIG. 4 is a view illustrating a first display example of the map screen displayed on the display 22. A map 50 and a level display 55 are displayed on the map screen illustrated in FIG. 4.

The map 50 schematically illustrates the topography of an area X among a plurality of areas set in this game.

In the level display 55, a level corresponding to the area X is displayed. In FIG. 4, “level 1” is displayed in the level display 55, and a case in which the level of the area X is “1” is illustrated.

A marker 60 and a marker 61 are displayed on the map 50. The marker 60 and the marker 61 are markers that are displayed in accordance with the current level 1 of the area X, and are placed in the map 50. Specifically, the marker 60 indicates an occurrence location of a search event A, and the marker 61 indicates an occurrence location of a collection event A. As a result, the player can cause the search event A to occur by moving the player character to a location indicated by the marker 60. Each of the marker 60 and the marker 61 is an example of the “additional marker” of the disclosure.

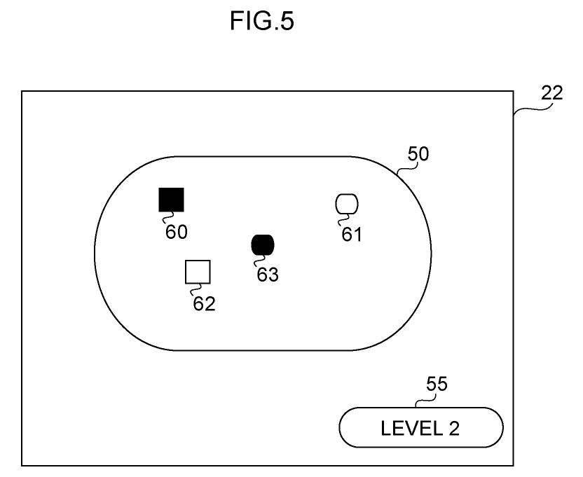

FIG. 5 is a view illustrating a second display example of the map screen displayed on the display 22. In FIG. 5, “level 2” is displayed in the level display 55, and a case in which the level of the area X has risen to “2” is illustrated.

When the level increases to level 2, a marker 62 and a marker 63 are additionally displayed on the map 50 illustrated in FIG. 5. The marker 62 and the marker 63 are markers that are displayed according to the current level 2 of the area X. As a result, in the state of level 2, a total of four markers from the marker 60 to the marker 63 are displayed.

Specifically, the marker 62 indicates an occurrence location of an environment improvement event A, and the marker 63 indicates an occurrence location of a famous site event A. For example, although the marker 62 is not displayed on the map 50 at level 1, the information is disclosed and displayed in a stepwise manner as the relationship of the player character with respect to the area X is deepened. The player can generate the environment improvement event A that contributes to the rising of the level by moving the player character to a location indicated by the marker 62. In this game, a new marker may be displayed on the map 50 by generating the environment improvement event A, and a guide line connecting a plurality of events is formed.

Each of the marker 62 and the marker 63 is an example of the “additional marker” of the disclosure. The event with the occurrence location indicated by the marker 62 or the marker 63 corresponds to either an unoccurring event or some events having occurred in the area X. Some events having occurred refer to, for example, an event that is useful for searching the area X and in which the player character has found a reusable landmark. As a specific example, a search event in which a specific location where the function of efficiently moving the player character is released is found corresponds to the above-described event.

On the other hand, an event not corresponding to some events having occurred is a one-time event, and has a property that the event does not occur even when the player visits that location again. Continuing to display the marker indicating the occurrence location of such an event on the map 50 not only does not bring a benefit to the player, but also may complicate the display content of the map 50 and cause a disadvantage to the player. Therefore, the marker that is displayed on the map 50 changes in a stepwise manner in a format of providing information useful for the player when the level increases.

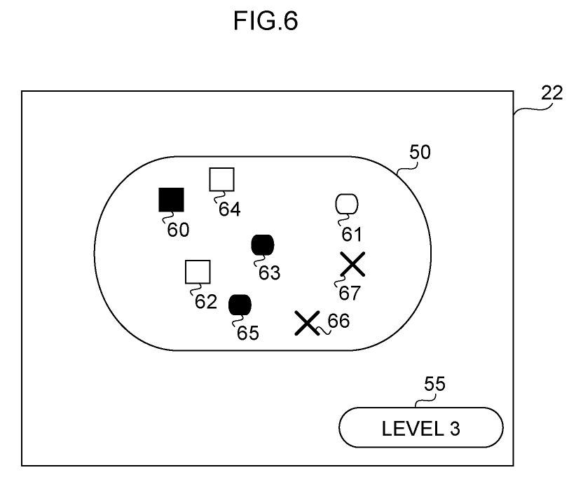

FIG. 6 is a view illustrating a third display example of the map screen displayed on the display 22. In FIG. 6, “level 3” is displayed in the level display 55, and a case in which the level of the area X has risen to “3” is illustrated.

By rising to level 3, a marker 64, a marker 65, a marker 66, and a marker 67 are additionally displayed on the map 50 illustrated in FIG. 6. The marker 64 to the marker 67 are markers that can be displayed in accordance with the current level 3 of the area X. In the state of level 3, all the markers set in the area X from the marker 60 to the marker 67 can be displayed. Each of the marker 64 to the marker 67 is an example of the “additional marker” of the disclosure.

Specifically, the marker 64 indicates an occurrence location of a symbolic action event A, and the marker 65 indicates an occurrence location of a search event B. The marker 66 indicates an occurrence location of an action event A, and the marker 67 indicates an occurrence location of a special event Z. The special event Z is a special event that occurs as a benefit obtained at the maximum level of the area X.

For example, although the marker 67 is not displayed on the map 50 at level 1 and level 2, the information is disclosed and displayed in a stepwise manner as the relationship of the player character with respect to the area X is deepened. The player can generate the special event Z as a benefit obtained at the maximum level of the area X by moving the player character to a location indicated by the marker 67.

As the benefit obtained at level “3” in the area X, in a case in which an event at which the reward is available occurs repeatedly in the area X in addition to the special event Z occurring at the location indicated by the marker 67, the reward is repeatedly provided to the player character. Specific examples of the “event at which the reward is available” include, but are not limited to, a random event (e.g.: a random event A or a random event B). For example a specific quest event, a challenge-type battle event, or the like may correspond to the “event at which the reward is available”.

Specific examples of the reward include, but are not limited to, acquisition of a specific item, and provision of an experience value, and include those that provide benefits to the player character in various forms such as acquisition of in-game currency and improvement of the ability value of the player character.

As described above, in this game, as the benefit obtained at level “3”, even in a case in which the same random event repeatedly occurs, no reward is given at level 2 or less even in the case of clearing the event, whereas a reward is given for each clearing of the event at level 3. As a result, even after raising the level of the area X to the maximum value, the player can obtain the reward through the repeatedly occurring event, and the motivation of the play in the area X is improved.

As described above, in this game, the CPU 11 of the information processing apparatus 10 changes display content of a marker that is displayed in the area on the map screen in accordance with the change in the index indicating the relationship of the player character with respect to the area. As a result, it is possible to manage occurrence locations of events in an area associated with a plurality of events in a stepwise manner. Since it is not necessary to individually design an occurrence location of each event and the occurrence locations can be uniformly managed in units of areas, the time and effort for designing can be greatly reduced. Therefore, according to the information processing apparatus 10, the time and effort required to design occurrence locations of events can be reduced as compared with the case of individually designing an occurrence location of each event in a game in which a plurality of events are set to occur.

In this game, the index is the level that is set for each area and increases when the relationship of the player character with respect to the area is deepened. The CPU 11 of the information processing apparatus 10 further changes display content of a marker that is displayed in the area to add a marker in the area with an increase in a level of the area. As a result, according to the information processing apparatus 10, by adding a marker that is displayed in the area with an increase in the level, which is the index set for the area, occurrence locations of events can be managed in a stepwise manner in this game in which a plurality of events are set to occur, and the time and effort required to design occurrence locations of events can be further reduced as compared with the case of individually designing an occurrence location of each event.

In this game, the level can be increased by the player character generating an event in the area. As a result, according to the information processing apparatus 10, since there is a case in which the level is increased by the player character generating an event in the area and the marker can be added, the action of the player character is reflected as a visual change of the map screen, and the sense of achievement of the search can be given.

When the level of the area increases, the CPU 11 of the information processing apparatus 10 further changes display content of a marker that is displayed in the area to add a marker indicating an occurrence location of at least one of an event that has not yet occurred or an event that has occurred but has not been cleared by the player. As a result, according to the information processing apparatus 10, by adding an additional marker indicating an occurrence location of at least one of an event that has not yet occurred or an event that has occurred but has not been cleared by the player when the level increases, the next action of the player character can be visually guided.

The CPU 11 of the information processing apparatus 10 repeatedly provides a reward to the player character in a case in which an event at which the reward is available as a benefit obtained at the maximum level repeatedly occurs in the area. As a result, according to the information processing apparatus 10, since the reward can be repeatedly provided to the player character at an event at which the reward is available as a benefit obtained at the maximum level, it is possible to give the player a continuous sense of achievement and improve motivation for continuing the play in the area.

### Others

Although the embodiments of the disclosure have been described in detail with reference to the accompanying drawings, the technical scope of the disclosure is not limited to such examples. It is obvious that a person having ordinary knowledge in the technical field of the disclosure can conceive various changes or modifications within the scope of the technical idea described in the claims, and it is naturally understood that these changes or modifications also belong to the technical scope of the disclosure.

The effects described in the above embodiment are illustrative or exemplary, and are not limited to those described in the above embodiment. That is, the technology according to the disclosure can exhibit other effects obvious to a person having ordinary knowledge in the technical field of the disclosure from the description in the above embodiment together with the effects described in the above embodiment or instead of the effects described in the above embodiment.

The processing described in the above embodiment can also be realized by a dedicated hardware circuit. In this case, the processing may be executed by one piece of hardware or may be executed by a plurality of pieces of hardware.

In the above embodiment, the rising of the level has been described as an example of the change in level. However, in this game, the change in level is not limited thereto, and a case in which the level decreases is also conceivable. For example, the CPU 11 may perform control to lower the level in a case in which the player character repeats a hostile action (e.g.: attacks on a resident in the area or execution of illegal acts).

In a case in which the level decreases, the CPU 11 may be configured to change the display of the marker on the map 50. For example, in a case in which the level decreases from level 2 to level 1, the trust of the resident for the player character is lost, and the marker indicating the occurrence location of the event having been previously displayed is not displayed.

In the above embodiment, as the “index indicating a relationship of a player character with respect to the area”, the “level set in the area” was used. However, the index is not limited thereof, and as a specific example of the index, the degree of reliability, reputation, and the like of the player character can also be used.

For example, in a case in which the “degree of reliability” is used as an index, the CPU 11 may perform control such that the player character follows a rule in the area and secures resources by a valid method to increase the degree of reliability, and the resident of the area shows cooperative behavior to the player character. On the other hand, in a case in which the player character takes a hostile action, the CPU 11 may perform control such that the degree of reliability is lowered and a specific facility becomes unusable or a specific resident shows a hostile reaction.

In a case in which the “reputation” is used as an index, the CPU 11 can perform control such that the player character also affects other areas outside the area. For example, in a case in which the reputation in a certain area (e.g.: area X) increases, the resident of the adjacent area (e.g.: area Y) recognizes the player character, and the first meeting attitude may be friendly.

As described above, by using an index having a different characteristic according to the action of the player character without limiting to the “level” as an index, it is possible to express the diversity of the relationship with the area and further deepen the depth of the game play.

In the above embodiment, the CPU 11 may change the state of a partner character acting with the player character in accordance with the rising of the level. For example in the case of level 1, the CPU 11 sets the partner character to a “search assist mode” and expands an item search range. On the other hand, in a case in which the level increases to level 2, the CPU 11 sets the partner character to a “battle assist mode”, analyzes the action of the enemy character, and assists the attack of the player character to control the battle to proceed advantageously.

In the above embodiment, the CPU 11 may change the topography of the area in accordance with the rising of the level. For example, in a case in which the level increases from level 1 to level 2, the CPU 11 removes an obstacle (e.g.: a collapsed bridge, a blocked cave, or a fallen tree) present in the area and opens a new search route.

In the above embodiment, the CPU 11 may change the response of a resident in the area to the player character in accordance with the rising of the level. For example, in a case in which the level increases from level 1 to level 2, the CPU 11 lowers the warning level of a specific resident, and makes it possible to deal with a conversation, a transaction, or the like that has not responded so far. For example, in a case in which the level increases from level 1 to level 2, the CPU 11 causes a new resident to appear in the area, and controls the number of requests that can be received by the player character to increase.

In the above embodiment, the CPU 11 may provide the player character with a special ability to be activated only within an area in accordance with the rising of the level. For example, in a case in which the level increases from level 1 to level 2, the CPU 11 gives the player character a camouflage ability that is less likely to be found from an enemy character only within the area.

In the above embodiment, the CPU 11 may change the flow of time of a facility in the area in accordance with the rising of the level. For example, in a case in which the level increases from level 1 to level 2, the CPU 11 extends the opening hours of a specific business and a specific atelier so that the player character can purchase an item and create an item even at night.

In the above embodiment, the CPU 11 may change the content of an item that can be acquired in the area in accordance with the rising of the level. For example, in a case in which the level increases from level 1 to level 2, the CPU 11 makes it possible to acquire a new rare item in addition to a general item.

In the above embodiment, the CPU 11 may change the state of another area adjacent to the area in accordance with the rising of the level. For example, in a case in which the level increases from level 1 to level 2, the CPU 11 reduces the power level of an enemy character placed in the adjacent area.

In the above embodiment, the CPU 11 may change attributes such as the type and quality of an item that can be created only within an area in accordance with the rising of the level. For example, in a case in which the level increases from level 1 to level 2, the CPU 11 makes it possible to create a specific rare item. In a case in which the level increases to level 3, the CPU 11 makes it possible to create a special specification item with improved performance even in the case of the same item.

In each of the above embodiments, the processors are defined in a broad sense, including a general processor (such as CPU: Central Processing Unit) and a dedicated processor (such as GPU: Graphics Processing Unit, ASIC: Application Specific Integrated Circuit, FPGA: Field Programmable Gate Array, or programmable logic device).

The operation of the processor in each of the above embodiments may be performed not only by one processor but also by a plurality of processors existing in collaboration which are located physically apart from each other. Alternatively, a plurality of operations performed by a plurality of specific processors in each of the above embodiments may be partially or entirely integrated and performed by one processor. The order of each operation of the processor is not limited to the order described in each of the above embodiments, and may be appropriately changed.

The technique of the disclosure can also be applied to a program and a program product.

All the literature, patent application, and technical standards cited herein are also herein incorporated to the same extent as provided for specifically and severally with respect to an individual literature, patent application, and technical standard to the effect that the same should be so incorporated by reference.

What is claimed is:

1. A non-transitory recording medium storing an information processing program that is executable by a computer to perform processing comprising:
in a game in which a marker indicating an occurrence location of each event in an area in which a plurality of events are set to occur is displayed on a map screen showing the area,
changing display content of a marker that is displayed in the area on the map screen in accordance with a change in an index indicating a relationship of a player character with respect to the area.

2. The non-transitory recording medium storing an information processing program according to claim 1, wherein the processing further comprises:
further changing display content of a marker that is displayed in the area to add a marker in the area with an increase in a level of the area,
wherein the index is the level, which is set for the area and increases when a relationship of the player character with respect to the area is deepened.

3. The non-transitory recording medium storing an information processing program according to claim 2, wherein the level is increased by the player character generating an event in the area.

4. The non-transitory recording medium storing an information processing program according to claim 2, wherein the processing further comprises:
further changing display content of a marker that is displayed in the area to add a marker indicating a location of at least one of an event that has not yet occurred or an event that has occurred but has not been cleared by the player, when a level of the area has been increased.

5. The non-transitory recording medium storing an information processing program according to claim 2, wherein the processing further comprises:
repeatedly providing a reward to the player character in a case in which an event at which the reward is available as a benefit obtained at the maximum level repeatedly occurs in the area.

6. An information processing method of causing a computer to execute processing comprising:
in a game in which a marker indicating an occurrence location of each event in an area in which a plurality of events are set to occur is displayed on a map screen showing the area,
changing display content of a marker that is displayed in the area on the map screen in accordance with a change in an index indicating a relationship of a player character with respect to the area.

7. An information processing apparatus comprising a processor,
wherein, in a game in which a marker indicating an occurrence location of each event in an area in which a plurality of events are set to occur is displayed on a map screen showing the area,
the processor changes display content of a marker that is displayed in the area on the map screen in accordance with a change in an index indicating a relationship of a player character with respect to the area.
